(19) United States
(12) Patent Application Publication
(10) Pub. No.: US 2008/0186841 A1
(43) Pub. Date: Aug. 7, 2008

(54) Method and System For Determining a Frequency Offset

(75) Inventors: Ho Wang Fung, Singapore (SG); Chin Keong Ho, Singapore (SG)

Correspondence Address: CROCKETT & CROCKETT, P.C., 26020 ACERO, SUITE 200, MISSION VIEJO, CA, 92691, US

(73) Assignee: AGENCY FOR SCIENCE, TECHNOLOGY AND RESEARCH

(21) Appl. No.: 11/573,634

(22) PCT Filed: Aug. 13, 2005
(86) PCT No.: PCT/SG05/00273

§ 371 Date: Oct. 31, 2007

Related U.S. Application Data
(60) Provisional application No. 60/601,331, filed on Aug. 13, 2004.

(51) Int. Cl. H04J 11/00

(52) U.S. Cl. 370/203

(57) ABSTRACT

A method for determining a frequency offset from a plurality of signal values is described wherein first correlation coefficients are determined from the signal values and second correlation coefficients are determined from the first correlation coefficients. The second correlation coefficients are linearly combined and the frequency offset is determined as the phase of the linear combination.

### FIELD OF THE INVENTION

The invention relates to a method and system for determining a frequency offset.

### BACKGROUND OF THE INVENTION

In practical data communication, the local oscillator frequency at a receiver is typically not identical to that of the signal carrier generated at a transmitter. This is for one due to circuit limitation and it arises when the receiver is in relative motion to the transmitter as Doppler shift is inevitably introduced to the carrier frequency.

A frequency offset may lead to inter-carrier interference (ICI). For a multicarrier system, such as one that adopts orthogonal frequency division multiplexing (OFDM), a residual frequency offset results in a significant performance degradation. There hence exists the need for carrier frequency offset estimation so that this effect can be compensated for.

A number of transmission formats, for example, the IEEE802.11a standard, among others for signal transmission over selective channels require that pilot symbols in the form of short preambles be delivered ahead of the data samples to allow the carrier frequency offset to be estimated by the receiver. Various approaches have been propounded for the purpose. Although the maximum likelihood estimation (MLE) solution has been formulated in [1], [2], [3], it involves an optimization search that is usually too computationally demanding for practical implementation. Other designs that maintain the Cramer-Rao bound (CRB) performance but with lower computational consumption have also been reported (see [2], [3]). In this regard, the ad hoc estimator (AHE) developed in [2] serves as an attractive candidate.

Consider the case that Pₛ identical short preambles, each of L symbols in length, denoted as x_{τ}+kLT_{b}=x_{τ}, 0≦τ≦LT_{c}, T_{b} being the bit interval and 0≦k≦Pₛ−1 an integer, are sent prior to the data stream in a data packet. For the IEEE802.11a specification, for instance, Pₛ=10 and L=16. After transmission through the channel, the Pₛ short preambles become zₜ=aₜ+\tilde{v}ₜ, where

$$\begin{matrix}{a}_{t} = {\int }_{- ∞}^{∞} {h}_{t - α} {x}_{α} d α \\ = {\int }_{- ∞}^{∞} {h}_{( t + LkTs ) - ( α + LkTs )} {x}_{α + {LkT}_{b}} d α \\ = {q}_{t + {LkT}_{b}}\end{matrix}$$

is periodic for LT_{b}≦t≦2LT_{b}, with the assumption that the maximum delay spread of the channel is less than the duration of one short preamble LT_{b} and hₜ is the channel gain and \tilde{v}ₜ is additive white gaussian noise (AWGN) of variance σ². The difference in the frequency of the local receiver oscillator from that of the carrier is reflected in the received short preambles yₜ=zₜe^{jΔβt} as an offset of Δβ, where −2π·0.5≦Δβ>2π·0.5. Since the first short preamble is corrupted by intersymbol interference and has to be disposed of, and some of the remaining ones are reserved for other purposes such as timing synchronization, it is supposed that only P<Pₛ received short preambles are available for frequency offset estimation. Then after sampling yₜ at t=(n+1)T_{b}, the PL discrete values yₙ can be expressed in matrix form as

$$\underline{Y} = {\underline{ba}}^{H} + \underline{V ,}$$

$$where$$

$$\underline{Y} • [ \begin{matrix}{y}_{0} & {y}_{1} & … & {y}_{L - 1} \\ {y}_{L} & {y}_{L + 1} & … & {y}_{2 L - 1} \\ ⋮ & ⋮ & ⋰ & ⋮ \\ {y}_{( P - 1 )} & {y}_{( P - 1 ) L + 1} & … & {y}_{PL - 1}\end{matrix} ]$$

$$\underline{b} • [ \begin{matrix}1 \\ {e}^{j ω} \\ ⋮ \\ {e}^{jω ( P - 1 )}\end{matrix} ]$$

$$ω• L Δ β$$

$${a}^{H} • [ {a}_{0} {a}_{1} {e}^{jΔ β} … {a}_{L - 1} {e}^{jΔ {β}_{( L - 1 )}} ]$$

$$\underline{V} • [ \begin{matrix}{v}_{0} & {v}_{1} & … & {v}_{L - 1} \\ {v}_{L} & {v}_{L + 1} & … & {v}_{2 L - 1} \\ ⋮ & ⋮ & ⋰ & ⋮ \\ {v}_{( P - 1 )} & {v}_{( P - 1 ) L + 1} & … & {v}_{PL - 1}\end{matrix} ]$$

with vₙ=\tilde{v}ₙe^{jΔβn} (n=0, 1, . . . , PL−1) sharing the same statistical properties with \tilde{v}ₙ, and can therefore be equivalently regarded as AWGN. The carrier frequency offset estimation (FOE) problem is now reduced to that of the estimation of ω, or rather Δβ, given Y.

One method for estimating Δβ is to perform a maximum likelihood estimation (MLE). It involves locating the peak of the periodogram of a one-dimensional correlation function of the received samples through a coarse search and subsequently a fine search. The Cramer-Rao bound (CRB), which marks the lowest achievable variance of an unbiased estimate, can be achieved above a certain thresholding signal-to-noise ratio (SNR).

Since every element in V is an independently Gaussian distributed variable, the maximum likelihood estimate of ω minimizes the cost function

J₀=trace(V^{H}V)

and is attained when a^{H} is estimated as â^{H}=(b^{H}b)⁻¹b^{H}Y and

$$\begin{matrix}{J}_{1} = trace \{ {\underline{Y}}^{H} {\underline{b} ( {\underline{b}}^{H} \underline{b} )}^{- 1} {\underline{b}}^{H} \underline{Y} \} \\ = \frac{trace ( {\underline{b}}^{H} {\underline{YY}}^{H} \underline{b} )}{P} \\ = \frac{{c}_{0} + 2 ℜ ( {\sum }_{k = 1}^{P - 1} {c}_{k} {e}^{- jω k} )}{P}\end{matrix}$$

is maximized, with

$${c}_{k } • {\sum }_{i = k}^{P - 1} {[ {YY}^{H} ]}_{i , i - k ,}$$

$$k = 0 , 1 , … , P - 1$$

being a measure of the correlation among the received samples, to yield

$$\hat{ω} = {arg}_{ω} max ℜ ( {\sum }_{k = 1}^{P - 1} {c}_{k} {e}^{- jω k} )$$

The denotation [YY^{H}]_{i,j}=0, 1, . . . , P−1 represents the (i,j)-th element of the matrix YY^{H} and [symbol] (.) the real component of the associated complex argument. An alternative approach to the above formulation can be found in [2]. Apart from the Fast Fourier transform (FFT) as adopted in [2], the above equation for \hat{ω} can be solved for using the Gauss-Newton method through the iteration equation

$${\hat{ω}}_{i + 1} = {\hat{ω}}_{i} + \frac{{\sum }_{k = 1}^{P - 1} k ( {c}_{k} {e}^{- j {\hat{ω}}_{i} k )}}{{\sum }_{k = 1}^{P - 1} k ℜ ( {c}_{k} {e}^{- j {\hat{ω}}_{i} k )}}$$

and an initial estimate \hat{ω}₀, with [symbol] (.) and ℑ(.) to denote the real and imaginary components of respective complex values. The key thus lies with the search for a robust initial estimate.

A problem of determining the maximum likelihood estimation solution is that the optimization of the nonlinear periodogram function is highly computationally costly. A realization using the Fast Fourier transform (FFT) with zero padding is usually adopted (see [1], [2]). An accurate estimate entails heavy padding and thus intense computation.

A quantitative account of the complexity has been detailed in [2].

Another prior art technique for frequency offset estimation is the ad hoc estimator (AHE), according to which the phases of the double correlation function of the received samples are linearly combined to minimize the mean square error in the estimation of carrier frequency offset (see [2]). The CRB can be attained at high SNRs.

However, the thresholding signal-to-noise ratio (SNR) rises substantially when the frequency offset value approaches the boundary of its range, that is, when Δβ→2π×0.5.

In [4] a frequency estimator for a single complex sinusoid in complex white Gaussian noise is described.

An object of the invention is to provide an improved method for frequency offset estimation compared to prior art methods.

The object is achieved by the method for determining a frequency offset and the system for determining a frequency offset with the features according to the independent claims.

### SUMMARY OF THE INVENTION

A method for determining a frequency offset from a plurality of signal values is provided, wherein a plurality of first correlation coefficients are determined from the signal values, wherein each first correlation coefficient is determined by determining the correlation between at least two of the signal values and a plurality of second correlation coefficients is determined from the plurality of first correlation coefficients, wherein each second correlation coefficient is determined by determining the correlation between at least two of the first correlation coefficients. The plurality of second correlation coefficients is linearly combined and the frequency offset is determined as the phase of the linear combination.

Further, a system for determining a frequency offset according to the method for determining a frequency offset described above are provided.

### SHORT DESCRIPTION OF THE FIGURES

FIG. 1 shows a communication system according to an embodiment of the invention.

FIG. 2 shows a frequency offset estimation unit according to an embodiment of the invention.

### DETAILED DESCRIPTION

Illustratively, a double correlation is carried out, the double correlation coefficients are processed by a linear filter and the phase of the output of the linear filter is used as an estimate for the frequency offset.

Simulations show that with the invention, performance almost as superior as that of the MLE (maximum likelihood estimator) can be achieved and that less sensitivity to variation in the actual amount of frequency offset when compared with the AHE (ad hoc estimator) can be achieved. The invention can be realized with a complexity comparable to that of the AHE.

The invention is for example applicable to communication systems according to WLAN 11n, WLAN 11g, WLAN 11 n, i.e. for wireless local area networks, but may also be applicable to large area communication systems such as mobile telephone communication systems. The invention can for example be used for determining the frequency offset in a communication system according to OFDM (orthogonal frequency division multiplexing).

Embodiments of the invention emerge from the dependent claims. The embodiments which are described in the context of the method for determining a frequency offset are analogously valid for the system for determining a frequency offset.

A second correlation coefficient is for example determined as the product of a first correlation coefficient and the complex conjugate of another first correlation coefficient.

The second correlation coefficients can be linearly combined by that each second correlation coefficient is multiplied by an integer, the results of these multiplications are summed and the sum is divided by a constant. The integer multiplication with double correlation terms can be efficiently implemented.

In one embodiment, the determination of the first correlation coefficients corresponds to arranging the signal values in a matrix, generating the auto-correlation matrix of the matrix and determining the first correlation coefficients as sums of elements along the diagonals of the auto-correlation matrix.

In one embodiment, the signal values correspond to a plurality of short preambles.

Illustrative embodiments of the invention are explained below with reference to the drawings.

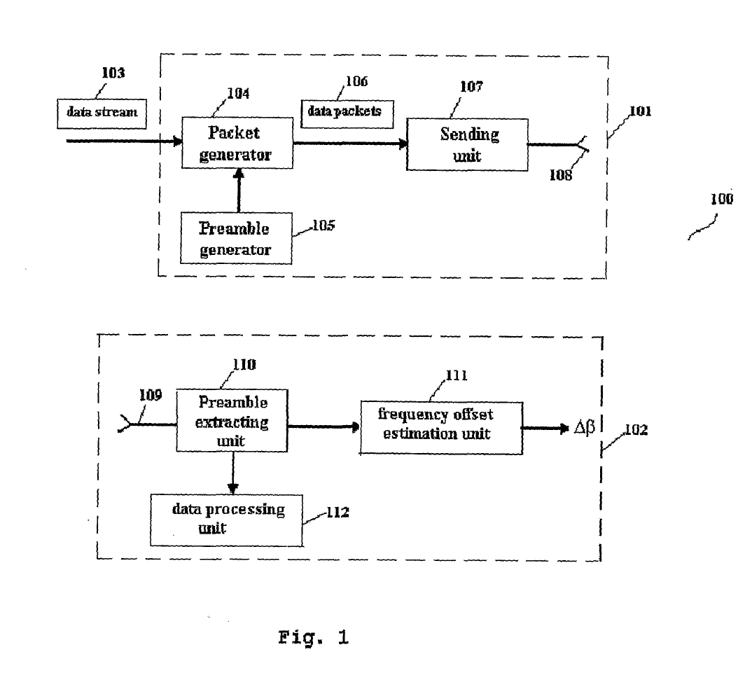

FIG. 1 shows a communication system 100 according to an embodiment of the invention.

The communication system 100 comprises a transmitter 101 and a receiver 102.

The transmitter 101 is supplied with a data stream 103 provided by some data source (not shown). The data stream 103 is fed into a packet generator 104 of the transmitter 101. The transmitter 101 further comprises a preamble generator 105 which generates preambles and supplies them to the packet generator 104.

The packet generator 104 forms data packets 106 from the data contained in the data stream 103 and puts preambles at the beginning of each data packet 106. In this embodiment, Pₛ identical short preambles, each of L symbols in length, denoted as x_{τ}+kLT_{b}=x_{τ}, 0≦τ≦LT_{b}, T_{b} being the bit interval and 0≦k≦Pₛ−1 an integer, are prepended to each data packet 106. For the IEEE802.11a specification, for instance, Pₛ=10 and L=16.

For example, according to the IEEE802.11a specification, each data packet 106 is prepended by Pₛ=10 identical short preambles, each of L=16 symbols in length.

The data packets 106 are supplied to a sending unit 107 which sends the data packets 106 using a transmit antenna 108. The sending unit 107 performs some sort of modulation, for example OFDM (orthogonal frequency division multiplexing) of at least one carrier which is sent by the sending antenna 108 to send the data packets 106. The communication system 100 may be a MIMO (multiple input multiple output) system. Accordingly, the data packets 106 may be sent using a plurality of sending antennas 108.

The data packets 106 sent by the transmitter 101 are received by the receiver 102 via a receiving antenna 109 and are supplied to a preamble extraction unit 110. The preamble extraction unit 110 forwards preamble values (explained in detail below) contained in the data packet 106 to a frequency offset estimation (FOE) unit 111 and forwards the actual data contained in the data packets 106 and corresponding to the data stream 103 to a data processing unit 112 which performs data processing, for example decodes the data and supplies the data to some data sink (not shown).

The FOE unit 111 determines a frequency offset estimation Δβ. The frequency offset estimation Δβ may for example be used by the data processing unit 112 to correct errors resulting from inter carrier interference caused by the frequency offset or to perform a phase compensation.

After transmission through the channel, the Pₛ short preambles of a data packet 106 become zₜ=aₜ+\tilde{v}ₜ, where

$$\begin{matrix}{a}_{t} = {\int }_{- ∞}^{∞} {h}_{t - α} {x}_{α} d α \\ = {\int }_{- ∞}^{∞} {h}_{( t + LkTs ( - ( α + LkTs )} {x}_{α + {LkT}_{b}} d α \\ = {a}_{t + {LkT}_{b}}\end{matrix} \qquad ( 1 )$$

is periodic for LT_{b}≦t≦2LT_{b}, with the assumption that the maximum delay spread of the channel is less than the duration of one short preamble LT_{b} and hₜ is the channel gain of the radio channel between the sending antenna 108 and the receiving antenna 109 and \tilde{v}ₜ is additive white gaussian noise (AWGN) of variance σ² which influences the data transmission between the transmitter 101 and the receiver 102. The difference in the frequency of the oscillator of the receiver 102 from that of the carrier used for the transmission of the data packets 106 is reflected in the received short preambles yₜ=zₜe^{jΔβt} as an offset of Δβ, where −2π·0.5≦Δβ≦2π·0.5.

Since the first short preamble is corrupted by intersymbol interference it is disposed of by the preamble extraction unit 110, and some of the remaining ones are reserved for other purposes such as timing synchronization, it is supposed that only P<Pₛ received short preambles are available for frequency offset estimation. The PL discrete values yₙ contained in these P received preambles are forwarded by the preamble extraction unit 110 to the frequency offset estimation unit 111.

The PL discrete values yₙ can be expressed in matrix form as

$$\begin{matrix}\underline{Y} = {\underline{ba}}^{H} + \underline{V ,} \\ where & ( 2 ) \\ \underline{Y} • [ \begin{matrix}{y}_{0} & {y}_{1} & … & {y}_{L - 1} \\ {y}_{L} & {y}_{L + 1} & … & {y}_{2 L - 1} \\ ⋮ & ⋮ & ⋱ & ⋮ \\ {y}_{( P - 1 )} & {y}_{( P - 1 ) L + 1} & … & {y}_{PL - 1}\end{matrix} ] & ( 3 ) \\ \underline{b} • [ \begin{matrix}1 \\ {e}^{jω} \\ ⋮ \\ {e}^{jω ( P - 1 )}\end{matrix} ] & ( 4 ) \\ ω • L Δ β & ( 5 ) \\ {a}^{H} • [ {a}_{0} {a}_{1} {e}^{jΔ β} … {a}_{L - 1} {e}^{jΔ β ( L - 1 )} ] & ( 6 ) \\ \underline{V} • [ \begin{matrix}{v}_{0} & {v}_{1} & … & {v}_{L - 1} \\ {v}_{L} & {v}_{L + 1} & … & {v}_{2 L - 1} \\ ⋮ & ⋮ & ⋱ & ⋮ \\ {v}_{( P - 1 )} & {v}_{( P - 1 ) L + 1} & … & {v}_{PL - 1}\end{matrix} ] & ( 7 )\end{matrix}$$

with vₙ=\tilde{v}ₙe^{jΔβn}, n=0, 1, . . . , PL−1 sharing the same statistical properties with \tilde{v}ₙ, and can therefore be equivalently regarded as AWGN. As mentioned above, the FOE unit 111 estimates Δβ.

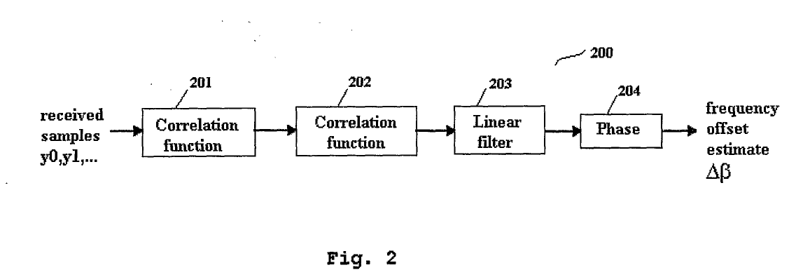

In the following, the functionality of the FOE unit 111 is explained with reference to FIG. 2.

FIG. 2 shows a frequency offset estimation unit 200 according to an embodiment of the invention.

As explained above, the frequency offset estimation (FOE) unit 200 receives as input PL discrete values yₙ contained in the short preambles of a data block. As mentioned, the values yₙ may be written in matrix form as (compare equation (3))

$$\underline{Y} • [ \begin{matrix}{y}_{0} & {y}_{1} & … & {y}_{L - 1} \\ {y}_{L} & {y}_{L + 1} & … & {y}_{2 L - 1} \\ ⋮ & ⋮ & ⋱ & ⋮ \\ {y}_{( P - 1 )} & {y}_{( P - 1 ) L + 1} & … & {y}_{PL - 1}\end{matrix} ]$$

In the absence of noise, Y=ba^{H} and the correlation term [YY^{H}]_{i,i-k} will be equal to (a^{H}a)e^{jωk} suggesting that e^{jωk} can be estimated from a linear combination of [YY^{H}]_{i,i-k} with different values of i. In turn, ω can be estimated from a separate linear combination of the products of the estimates for e^{jω(k+1)} and (e^{jωk})*.

Given [YY^{H}]_{i,i-k}, i=k, k+1, . . . , P−1, it can be shown that the minimum variance unbiased estimator (see [4]) of e^{jωk} at a high signal-to-noise ratio (SNR) is cₖ/[(P−k) (a^{H}a)], where

$${c}_{k} • {\sum }_{i = k}^{P - 1} {[ {YY}^{H} ]}_{i , i - k ,}$$

$$k = 0 , 1 , … , P - 1$$

(8) implying that cₖ is an optimal linear estimator for e^{jωk} after scaling. Introducing the double correlation term dₖ, defined as

$${d}_{k} • {c}_{k + 1} {c}_{k}^{*} = {( {\underline{a}}^{H} \underline{a} )}^{2} {e}^{jω} + {n}_{k} \qquad ( 9 )$$

it can be shown that the noise component nₖ in dₖ has an autocorrelation of

[R]_{k,m} [symbol] E(nₖnₘ*)=2(a^{H}a)³σ²{(P−k−1)(P−m−1)[P−max(k,m)]+(P−k)(P−m)[P−max(k+1,m+1)]+(P−k−1)(P−m)[max(P−k−m−1,0)]+(P−k)(P−m−1)[P−k−m−1,0]}

at high SNRs. By expressing (9) in matrix form,

d=(a^{H}a)²ρ·e^{jω}+n (10)

where the kth element, k=0, 1, . . . , P−2 of the column vector ρ is [ρ]ₖ [symbol] (P−k) (P−k−1), the minimum variance unbiased estimator (see [4]) of k□e^{jω}, which minimizes the cost function

[d−(a^{H}a)²ρ·e^{jω}]^{H}R⁻¹[d−(a^{H}a)²ρ·e^{jω}] (11)

is

$${\hat{λ}}_{ODC} = \frac{1}{{( {\underline{a}}^{H} \underline{a} )}^{2}} \cdot \frac{{\underline{ρ}}^{T} {\underline{R}}^{- 1} \underline{d}}{{\underline{ρ}}^{T} {\underline{R}}^{- 1} \underline{ρ}} . \qquad ( 12 )$$

The frequency of interest ω can then be estimated as

$${\hat{ω}}_{ODC} = ∠ [ \frac{1}{{( {\underline{a}}^{H} \underline{a} )}^{2}} \cdot \frac{{\underline{ρ}}^{T} {\underline{R}}^{- 1} \underline{d}}{{\underline{ρ}}^{T} {\underline{R}}^{- 1} \underline{ρ}} ] = ∠ ( {\underline{ρ}}^{T} {\underline{R}}^{- 1} \underline{d} ) \qquad ( 13 )$$

since (a^{H}a)²(ρ^{T}R⁻¹ρ) is real.

An attempt to obtain

g=R⁻¹ρ (14)

as required by (13) is made by assuming that the elements in g can be described by a polynomial. Numerical results support the supposition and reveal that the polynomial is linear, i.e., R[1 t] [μ₀ μ₁]^{T}=ρ where t=[0 1 2 . . . P−2]^{T} and μ₀, μ₁ are coefficients to be determined. Expanding the equation and comparing terms leads to

$$[ \begin{matrix}{μ}_{0} \\ {μ}_{1}\end{matrix} ] = \frac{1}{2 {( {\underline{a}}^{H} \underline{a} )}^{3} {σ}^{2}} \cdot \frac{6}{P ( 4 {P}^{2} - 1 )} [ \begin{matrix}1 \\ 2\end{matrix} ] \qquad ( 15 )$$

implying that, after some algebraic manipulations,

$$\begin{matrix}{[ {\underline{R}}^{- 1} \underline{1} ]}_{k} = {[ \underline{g} ]}_{k} \\ = {μ}_{0} + {μ}_{1} k \\ = \frac{1}{2 {( {\underline{a}}^{H} \underline{a} )}^{3} {σ}^{2}} \cdot \frac{6}{P ( 4 {P}^{2} - 1 )}\end{matrix} \qquad ( 16 )$$

Back substitution with (10) and (16) verify that

$${\sum }_{m = 0}^{P - 1} {{[ \underline{R} ]}_{k , m} [ \underline{g} ]}_{m} = ( P - k ) ( P - k - 1 ) ,$$

∀k=0, 1, . . . , P−2. It follows from (13) and (16) that

$${ODC}_{} = ∠ ( {\underline{g}}^{T} \underline{d} ) \\ = ∠ {\sum }_{k = 0}^{P - 2} ( 2 k + 1 ) {d}_{k} \qquad ( 17 )$$

Accordingly, the frequency offset estimator 200 estimates Δβ according to

$$Δ β = \frac{{ODC}_{}}{L} = \frac{∠ {\sum }_{k = 0}^{P - 2} ( 2 k + 1 ) {d}_{k}}{L}$$

The signal values yₙ are therefore fed to a first correlation unit 201 which determines the

$${c}_{k} • {\sum }_{i = k}^{P - 1} {[ {YY}^{H} ]}_{i , i - k ,}$$

$$k = 0 , 1 , … , P - 1.$$

The cₖ are fed to a second correlation unit 202 which determines the

$${d}_{k} = {c}_{k + 1} {c}_{k}^{*}$$

The dₖ are fed to a linear filter 203 which calculates

$${\sum }_{k = 0}^{P - 2} ( 2 k + 1 ) {d}_{k} .$$

The result of this calculation is supplied to a phase determination unit which determines the phase of this result and divides it by L, i.e., determines

$$Δ β = \frac{{∠ \sum }_{k = 0}^{P - 2} ( 2 k + 1 ) {d}_{k}}{L}$$

which is the output of the frequency offset estimation unit 200.

In contrast to the ad hoc estimator (AHE) reported in [2], given by

$$AHE = {\sum }_{k = 0}^{M - 1} 3 \frac{( P - k - 1 ) ( P - k ) - M ( P - M )}{M ( 4 {M}^{2} - 6 PM + 3 {P}^{2} - 1 )} ∠ {d}_{k} \qquad ( 18 )$$

with M=P/2, which allocates weights to the phase of the double correlation terms, the proposed strategy filters the double correlation terms before the phase is taken. From (17) and (18), it is obvious that the ODC (optimal double correlation) filter as used in this embodiment is of a similar order of complexity to that of the AHE (ad hoc estimator), which has been shown in [2] to be substantially lower than that of the MLE realized using FFT (Fast Fourier transformation). Further, the ODC filter adopts weights of integer values. Therefore a simple hardware implementation is possible.

The above derivation seeks to minimize the variance in the estimation of λ [symbol] e^{jω}, although the ultimate objective is to minimize that in ω. In the following, the performance of the proposed filter is studied by first relating these two criterion.

Consider the complex quantity ψ=Ae^{jθ}. Taking the differential of ψ gives Δψ=e^{jθ}ΔA+jAe^{jθ}Δθ and

$$\begin{matrix}{\vert Δ ψ \vert}^{2} = {( {e}^{j θ} Δ A + j A {e}^{j θ} Δ θ )}^{*} ( {e}^{j θ} Δ A + j A {e}^{j θ} Δ θ ) \\ = {( Δ A )}^{2} + {{A}^{2} ( Δ θ )}^{2}\end{matrix} \qquad ( 19 )$$

where (.)* stands for conjugate operation. By writing A=(ψ*ψ)^{1/2}, ΔA becomes

$$Δ A = \frac{{ψ}^{*} ( Δ ψ ) + ( Δ {ψ}^{*} ) ψ}{2 A} \qquad ( 20 )$$

Substituting (20) into (19) and rearranging yields

$${( Δ θ )}^{2} = ( \frac{1}{{A}^{2}} - \frac{{\vert ψ \vert}^{2}}{2 {A}^{4}} ) {\vert Δ ψ \vert}^{2} - \frac{{[ {ψ}^{*} ( Δψ ) ]}^{2} + {[ {( Δ ψ )}^{*} ψ ]}^{2}}{4 A} . \qquad ( 21 )$$

Applying the result in (21) to the estimation of λ by (12) calls for the substitutions ψ=λ=e^{jω}, A=1, and θ=ω to produce

$${( Δ {ω}_{ODC} )}^{2} = \frac{{\vert Δ {λ}_{ODC} \vert}^{2}}{2} - \frac{{[ {e}^{- j ω} ( Δ {λ}_{ODC} ) ]}^{2} + {[ {{e}^{j ω} ( Δ {λ}_{ODC} )}^{*} ]}^{2}}{4} \qquad ( 22 )$$

Now substituting (10) into (12) leads to

$$Δ {λ}_{ODC} = {\hat{λ}}_{ODC} - {e}^{j ω} = \frac{1}{{( {\underline{a}}^{H} \underline{a} )}^{2}} \cdot \frac{{\underline{ρ}}^{T} {\underline{R}}^{- 1} \underline{n}}{{\underline{ρ}}^{T} {\underline{R}}^{- 1} \underline{ρ}} = \frac{1}{{( {\underline{a}}^{H} \underline{a} )}^{2}} \cdot \frac{{\underline{g}}^{T} \underline{n}}{{\underline{g}}^{T} \underline{ρ}} \qquad ( 23 )$$

as E(nn^{H})=R and with g given in (16), and therefore,

$$E ( {\vert Δ {λ}_{ODC} \vert}^{2} ) = \frac{1}{{( {\underline{a}}^{H} \underline{a} )}^{4} ( {\underline{g}}^{T} \underline{ρ} )} \\ {E [ {e}^{- jω} ( Δ {λ}_{ODC} ) ]}^{2} = \frac{E [ {{e}^{- j ω 2} ( {\underline{g}}^{T} \underline{n} )}^{2} ]}{{[ {( {\underline{a}}^{H} \underline{a} )}^{2} {\underline{g}}^{T} \underline{ρ} ]}^{2}} \\ {E [ {{e}^{jω} ( Δ {λ}_{ODC} )}^{*} ]}^{2} \frac{E [ {{e}^{j ω 2} ( {\underline{n}}^{H} \underline{g} )}^{2} ]}{{[ {( {\underline{a}}^{H} \underline{a} )}^{2} {\underline{g}}^{T} \underline{ρ} ]}^{2}} \qquad ( 24 )$$

It can be shown that

$$E [ {{e}^{- jω 2} ( {\underline{g}}^{T} \underline{n} )}^{2} ] = E [ {{e}^{jω 2} ( {\underline{n}}^{H} \underline{g} )}^{2} ] = \frac{P ( {P}^{2} - 1 ) ( 4 {P}^{2} - 7 )}{2 {( {\underline{a}}^{H} \underline{a} )}^{3} {{σ}^{2} ( 4 {P}^{2} - 1 )}^{2}} \qquad ( 25 )$$

Substituting (24) and (25) into the expectation of (22), and using the result

$${\underline{g}}^{T} \underline{ρ} = {\sum }_{k = 0}^{P - 2} {g}_{k} ( P - k ) ( P - k - 1 ) = \frac{1}{2 {( {\underline{a}}^{H} \underline{a} )}^{3} {σ}^{2}} \cdot \frac{P ( {P}^{2} - 1 )}{4 {P}^{2} - 1} \qquad ( 26 )$$

yield the mean squared error

$$MSE ( {ω}_{ODC} ) = E [ {( Δ {ω}_{ODC} )}^{2} ] = \frac{6}{\frac{{\underline{a}}^{H} \underline{a}}{{σ}^{2}} P ( {P}^{2} - 1 )} = CRB ( ω ) \qquad ( 27 )$$

which is the Cramer-Rao bound (CRB) for the estimation of e (see [2]), indicating that the proposed double correlation filter achieves optimal performance at high SNRs. The corresponding MSE in the frequency offset Δβ=ω/L as related in (3) is therefore

$$MSE ( Δ {β}_{ODC} ) = \frac{6}{SNR \cdot P ( {P}^{2} - 1 ) \cdot {L}^{3}} = CRB ( Δ β ) \qquad ( 28 )$$

where SNR=(a^{H}a)/(Lσ²) quantifies the signal-to-noise ratio in short preambles.

Simulations show that the mean squared error (MSE) of the carrier frequency offset estimate at a high signal-to-noise ratio equals to the Cramer-Rao bound (CRB) for the estimation of Δβ. This indicates optimal performance at high SNRs. The Almost as good a performance as with MLE (maximum likelihood estimation) can be achieved and an improvement in robustness to variation in the actual carrier frequency offset value over the AHE is provided. The FOE unit 200 (also denoted as ODC filter) has a low computational complexity comparable to that of the AHE (ad hoc estimator), which in turn has been shown in [2] to be significantly lower that that of the MLE realized using FFT.

The computationaly intensity of the FOE unit 200 is shown in Table 1.

TABLE 1

| | Multiplication | Addition |
|---|---|---|
| Y Y^{H} | LP(P + 1)/2 | (L − 1)P(P + 1)/2 |
| cₖ | 0 | P(P − 1)/2 |
| dₖ | P − 1 | 0 |

The computational intensity for subsequent operations, compared to the ad-hoc estimator according to prior art is illustrated in Table 2

TABLE 2

| | | Optimal double |
|---|---|---|
| | Ad-hoc estimator | correlator |
| Phase computation | P/2 | 1 |
| Multiplications | P/2 (floating | P − 1 (simple |
| | point mult) | integer mult) |
| Additions | P/2 − 1 | P − 2 |

Further, using the invention, e.g. the embodiment described above, a relaxation of specification in local receiver oscillator frequency offset can be achieved. For example, the current specification for IEEE802.11a is 20 ppm (parts per million) in the transmitter and the receiver, which, for a system of carrier and sampling frequencies of 5 GHz and 20 MHz respectively, translates to a maximum digital frequency offset of

$$ω = 20 \times {10}^{- 6} \times \frac{5 \times {10}^{9}}{20 \times {10}^{6}} \times 2 = 0.01 Hz$$

$$Δ β = ω L = 0.16 Hz$$

With the above embodiment, the tolerance can reach as high as to 0.45 Hz, as can be demonstrated through simulation at SNR=0 dB, which equivalently eases the oscillator accuracy from 20 ppm to

20×0.45/0.16=56 ppm

by more than 2.5 times.

In this document, the following publications are cited:
[1] J. Li, G. Liu, and G. B. Giannakis, “Carrier frequency offset estimation for OFDM-Based WLANs”, IEEE Signal Processing Letters, pp. 80-82, vol. 8, no. 3, March 2001
[2] M. Morelli and U. Mengali, “Carrier-frequency estimation for transmissions over selective channels”, IEEE Transactions on Communications, pp. 1580-1589, vol. 48, no. 9, September 2000
[3] J. Lei and T-S. Ng, “Periodogram-based carrier frequency offset estimation for orthogonal frequency division multiplexing applications”, IEEE Global Telecommunications Conference, GLOBECOM '01, pp. 3070-3074, vol. 5, 2001
[4] S. Kay, “Statistically/Computationally efficient frequency estimation”, ICASSP'98, pp. 2292-2294, vol. 4, 1998

1. A Method for determining a frequency offset from a plurality of signal values, wherein:
a plurality of first correlation coefficients are determined from the signal values, wherein each first correlation coefficient is determined by determining the correlation between at least two of the signal values;
a plurality of second correlation coefficients is determined from the plurality of first correlation coefficients, wherein each second correlation coefficient is determined by determining the correlation between at least two of the first correlation coefficients;
the plurality of second correlation coefficients is linearly combined;
the frequency offset is determined as the phase of the linear combination.

2. The method according to claim 1, wherein a second correlation coefficient is determined as the product of a first correlation coefficient and the complex conjugate of another first correlation coefficient

3. The method according to claim 1, wherein the second correlation coefficients are linearly combined by that each second correlation coefficient is multiplied by an integer, the results of these multiplications are summed and the sum is divided by a constant

4. The method according to claim 1, wherein the determination of the first correlation coefficients corresponds to arranging the signal values in a matrix, generating the auto-correlation matrix of the matrix and determining the first correlation coefficients as sums of elements along the diagonals of the auto-correlation matrix.

5. The method according to claim 1, wherein the signal values correspond to a plurality of short preambles.

6. A system for determining a frequency offset from a plurality of signal values, the system comprising:
a first correlation unit, adapted to determine a plurality of first correlation coefficients from the signal values, wherein each first correlation coefficient is determined by determining the correlation between at least two of the signal values;
a second correlation unit, adapted to determine a plurality of second correlation coefficients from the plurality of first correlation coefficients, wherein each second correlation coefficient is determined by determining the correlation between at least two of the first correlation coefficients;
a combiner, adapted to linearly combine the plurality of second correlation coefficients; and
a phase determination unit adapted to determine the frequency offset as the phase of the linear combination.
